(19) United States
(12) Patent Application Publication
(10) Pub. No.: US 2005/0172681 A1
(43) Pub. Date: Aug. 11, 2005

(54) Padlock-type lock for suitcases, trunks and the like

(76) Inventor: Massimo Tonelli, Casalecchio Di Reno (IT)

Correspondence Address: MODIANO & ASSOCIATI, Via Meravigli, 16, MILANO, 20123, IT

(21) Appl. No.: 11/042,072

(22) Filed: Jan. 26, 2005

(30) Foreign Application Priority Data
Jan. 26, 2004 (IT) BO2004U000005

(51) Int. Cl. E05B 67/36; F16B 41/00

(52) U.S. Cl. 70/33; 70/232

(57) ABSTRACT

A padlock-type lock for suitcases and us of the type constituted by a first half-shell and a second half-shell which are mutually articulated, comprising at least one padlock in which the locking bar is engaged, in a closed configuration, in a first through hole and in a second through hole, which are coaxial and are provided respectively in the first edge and in the second edge of the first half-shell and the second half-shells the padlock forming surfaces for mating with the first first edge and with the second edge, so that in the closed configuration the padlock is retained in a preset safe and minimum-protrusion position.

The present invention relates to a padlock-type lock for suitcases, trunks and the like.

### BACKGROUND OF THE INVENTION

Many commercially available suitcases and trunks, for example those intended for professional uses, have locks provided with at least one padlock of the key-operated, combination or other type, in which the locking bar is engaged in a respective through hole formed through the edges of the first and second articulated half-shells of the suitcase.

Due to the unavoidable coupling clearance provided between the locking bar and the hole through the edges of the suitcase, the padlock can move accidentally, for example rotate about the locking bar, during ordinary use, handling and transfer of the suitcase.

This phenomenon is absolutely unpleasant and unwelcome, since it can cause damage to the surface of the suitcase or to other items, and can also constitute a potential danger for the user, since the padlock constitutes, in this situation, a blunt object that can cause injuries.

### SUMMARY OF THE INVENTION

The aim of the present invention is to obviate the above-mentioned drawback, by providing a lock for suitcases, trunks and the like in which the padlock is prevented from performing accidental movements and is therefore suitable to prevent potential damage to objects or people.

Within this aim, an object of the present invention is to provide a lock that is substantially universal, i.e., adaptable to any suitcase or trunk of the type constituted by two mutually articulated half-shells.

Another object of the present invention is to provide a lock that is simple, relatively easy to provide in practice, safe in use, effective in operation, and has a relatively low cost.

This aim and this and other objects that will become better apparent hereinafter are achieved by the present lock for suitcases, trunks and the like, of the type constituted by a first half-shell and a second half-shell which are mutually articulated, comprising at least one padlock in which a locking bar is engaged, in a closed configuration, in a first through hole and in a second through hole, which are coaxial and are provided respectively in the first edge and in the second edge of said first half-shell and said second half-shell, characterized in that said padlock forms surfaces for mating with said first edge and with said second edge so that in a closed configuration said padlock is retained in a preset safe position that provides minimum protrusion.

### BRIEF DESCRIPTION OF THE DRAWINGS

Further characteristics and advantages of the present invention will become better apparent from the following detailed description of a preferred but not exclusive embodiment of a padlock-type lock for suitcases, trunks and the like according to the invention, illustrated by way of non-limiting example in the accompanying drawings, wherein:

FIG. 1 is a perspective view of a suitcase closed with a lock according to the invention;

FIG. 2 is a detail perspective view of the lock, with the padlock disengaged from the edges of the half-shells of the suitcase;

FIG. 3 is another perspective view of the padlock of the lock according to the invention;

FIG. 4 is a plan view of the padlock.

### DESCRIPTION OF THE PREFERRED EMBODIMENTS

In the embodiments that follow, individual characteristics, may actually be interchanged with other different characteristics that exist in other embodiments.

Moreover, it is noted that anything found to be already known during the patenting process is understood not to be claimed and to be the subject of a disclaimer.

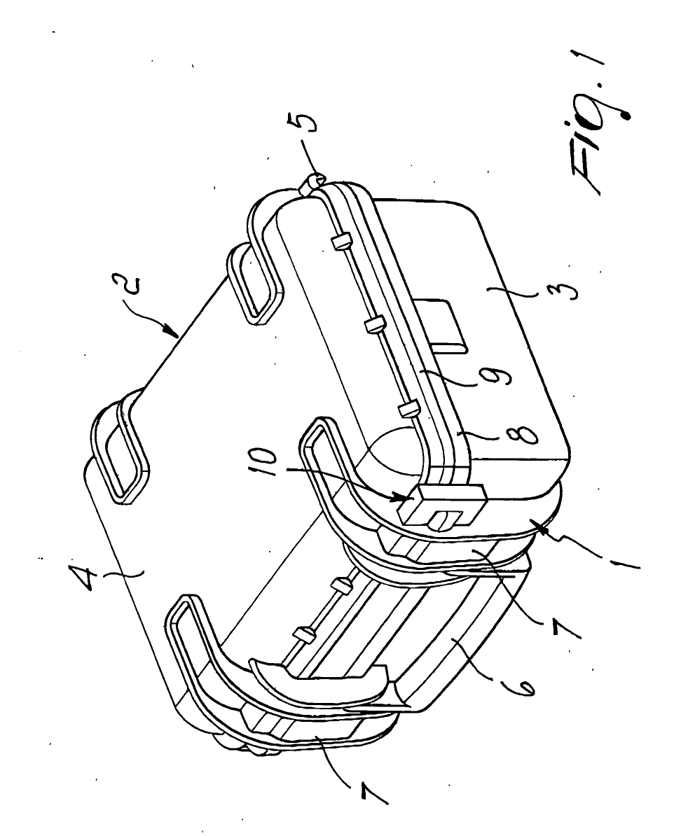

With reference to FIG. 1, the reference numeral 1 generally designates a lock for suitcases, trunks and the like according to the invention: the lock 1 is installed, in the specific embodiment described hereinafter, on a tool-carrying case, generally designated by the reference numeral 2, particularly for professional uses. However, it is noted that the lock according to the invention is extremely versatile and adaptable to any kind of suitcase or trunk of any size and for any use.

The case 2, shown in FIG. 1, is of the type constituted by a first half-shell 3 and by a second half-shell 4, which are mutually articulated at hinges 5, and is provided with at least one grip handle 6. Two locking elements 7 are provided at the sides of the handle, are hinged to one of the half-shells 3 and 4 and are suitable to keep said half-shells in contact with each other when the suitcase is closed. The first half-shell 3 and the second half-shell 4 form respectively a first perimetric edge 8 and a second perimetric edge 9, which are in mutual contact when the suitcase is in the closed configuration.

The lock is constituted by a padlock 10, for example of the type that can be operated by means of a key or by means of a device with a numeric combination, provided with a cylindrical locking bar 11 that is suitable to be inserted in a first through hole 12 formed in the first edge 8 and in a second through hole 13 formed in the second edge 9, such holes being mutually coaxial (FIG. 2).

The padlock 10 is preferably of the type that has a substantially U-shape casing, which forms a first end portion 14, affected by a through channel 15 along which the bar 11 is engaged so that it can slide, and a second end portion 16, in which there is a receptacle 17 provided with means for selectively locking the end of the bar 11, which can be operated for example with a key in an appropriately provided lock 18, or alternatively by way of a device with a numeric combination.

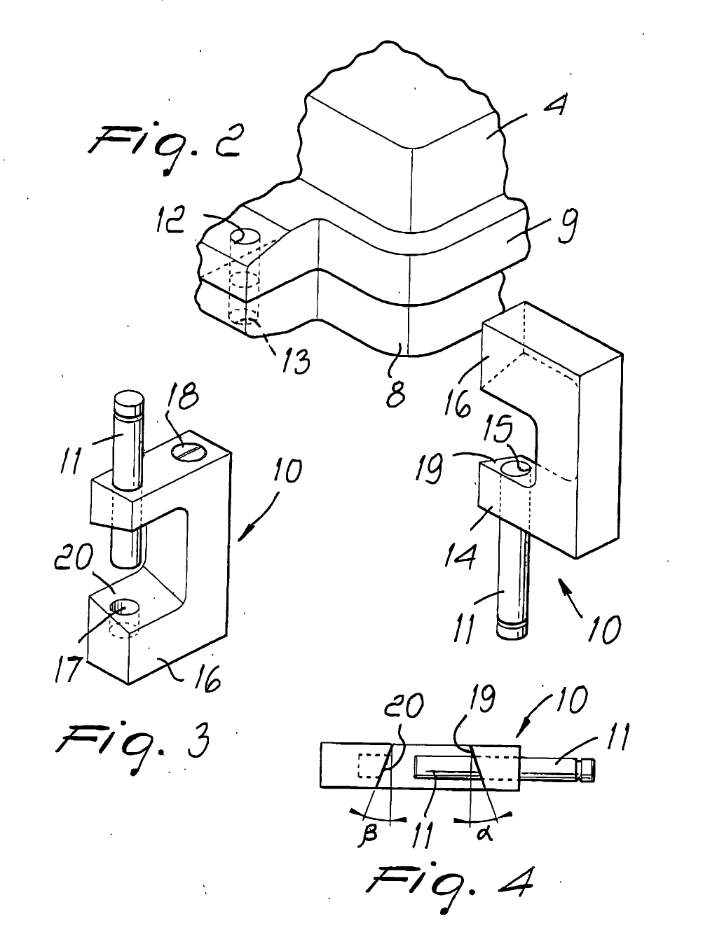

According to the invention, the first end portion 14 and the second end portion 16 of the padlock 10 form respectively a first surface 19 and a second surface 20 for mating with the first edge 8 and the second edge 9 (FIG. 3), so that when the suitcase is closed the padlock 10 is retained stably in a preset safe and minimum-protrusion position, shown in FIG. 1; in this position, the padlock 10 cannot perform accidental movements, caused by the displacement of the suitcase during its use, which might damage the surface of the suitcase, other objects or even people.

Advantageously, the first mating surface 19 is flat and inclined, by a preset angle α, with respect to a plane that is perpendicular to the axis of the bar 11 (FIG. 4). The first edge 8 has, at the first hole 12, a profile that is inclined by the same first angle α with respect to the ideal plane traced by the perimeter of the first edge 8.

The second surface 20 is likewise flat and inclined, with respect to the axis of the bar 11, by a second preset angle β (FIG. 4); at the second hole 13, the second edge 9 forms a profile that is inclined by the same second angle β with respect to the ideal plane traced by the perimeter of the second edge 9. In this manner, the first and second edges 8, 9 arranged mutually adjacent, when the suitcase is in the closed configuration, form a sort of wedge, which mates with the first surface 19 and with the second surface 20, so as to prevent accidental movements or rotations of the padlock 10 from the safe and minimum-protrusion position in which it is locked.

The first preset angle α and the second preset angle β preferably have the same value, which in the specific embodiment shown in the figures is 18° and is given here merely as a non-limiting example.

It has thus been shown that the invention achieves the intended aim and objects. The described lock ensures that the locking padlock 10 is retained stably in a safe and minimum-protrusion position, from which it cannot move accidentally, causing damage to said suitcase, to other objects and to people.

The invention thus conceived is susceptible of numerous modifications and variations, all of which are within the scope of the inventive concept.

All the details may further be replaced with other technically equivalent ones.

In practice, the materials used, as well as the shapes and the dimensions, may be any according to requirements without thereby abandoning the scope of the protection of the appended claims.

The disclosures in Italian Utility Model Patent Application No. BO2004U000005 from which this application claims priority are incorporated herein by reference.

1. A padlock-type lock for suitcases and trunks of the type constituted by a first half-shell and a second half-shell which are mutually articulated, comprising at least one padlock in which a locking bar is engaged, in a closed configuration, in a first through hole and in a second through hole, which are coaxial and are provided respectively in the edge and in the second edge of said first half-shell and said second half-shell, wherein said padlock forms surfaces for mating with said first edge and with said second edge, so that in the closed configuration said padlock is retained in a preset safe and minimum-protrusion position.

2. The lock of claim 1, wherein said padlock is of the type having a casing substantially U-shaped and forming a first end portion, which is affected by a through channel in which said locking bar is engaged so that it can slide, and a second end portion, which has a receptacle in which there are means for selective locking of an end of said looking bar, and wherein said mating surfaces are two, namely a first surface provided on said first end portion and a second surface provided on said second end portion.

3. The lock of claim 2, wherein said first surface is substantially flat and is arranged at a first preset angle (α) with respect to a plane that is perpendicular to an axis of said bar, said first edge having, at said first through hole, a profile that is inclined by said first angle (α) with respect to a plane traced by said first edge.

4. The lock of claim 3, wherein said second surface is substantially flat and is arranged at a second preset angle (β) with respect to a plane that is perpendicular to the axis of said bar, said second edge having, at said second hole, a profile that is inclined by said second angle (β) with respect to a plane traced by said second edge.

5. The lock of claim 4, wherein said first preset angle (α) and said second preset angle (β) are identical.
